(19) United States
(12) Patent Application Publication
(10) Pub. No.: US 2017/0298886 A1
(43) Pub. Date: Oct. 19, 2017

(54) HIGH PRESSURE FUEL PUMP

(71) Applicant: MOTONIC CORPORATION, Seoul (KR)

(72) Inventors: Sang Ryul LEE, Daegu (KR); Jun Hyeok LEE, Daegu (KR); Myung Sub SHIM, Daegu (KR); Dong Sub KIM, Daegu (KR); Jae Hyuk HEO, Daegu (KR); Hee Jun YOUN, Daegu (KR)

(21) Appl. No.: 15/482,158

(22) Filed: Apr. 7, 2017

(30) Foreign Application Priority Data
Apr. 19, 2016 (KR) 10-2016-0047297

(51) Int. Cl. F02M 63/00; F04B 53/10; F02M 59/10; F02M 59/44; F04B 53/16; F04B 23/02

(52) U.S. Cl. CPC F02M 63/005; F04B 53/16; F04B 53/10; F04B 23/02; F02M 59/102; F02M 63/0036; F02M 59/442; F02M 63/0054

(57) ABSTRACT

Provided is a high pressure fuel pump including: a body formed in a side surface thereof with a discharge hole; a pressurizing device for generating a suction force for sucking fuel supplied from a fuel tank and a pressurizing force for pressurizing the fuel at a high pressure; a seal carrier coupled to a lower portion of the body and coupled with the pressurizing device; a flow control valve coupled to one side of the body, for controlling a supply flow rate and a discharge pressure of the fuel; and a pressure relief valve for relieving an abnormal high pressure by transferring a part of discharged fuel to a low pressure space formed in the lower portion of the body when the abnormal high pressure exceeding a preset pressure limit is generated in a fuel supply system for supplying the fuel discharged through the discharge hole to an injector.

### BACKGROUND OF THE INVENTION

### 1. Field of the Invention

The present invention relates to a high pressure fuel pump, and more particularly, to a high pressure fuel pump for a gasoline direct injection engine which compresses fuel to a high pressure and supplies the fuel to an injector so as to directly inject the fuel into a cylinder.

### 2. Description of the Related Art

In general, a technology for a gasoline direct injection (GDI) engine is under development to improve the fuel efficiency and performance of a gasoline engine. In a combustion process of a conventional gasoline engine, the conventional gasoline engine generates power by suction/compression/ignition/explosion/exhaustion processes of an air/fuel mixture, whereas the gasoline direct injection engine sucks and compresses only air and then injects fuel, which is similar to a compression ignition method of a diesel engine.

Accordingly, the gasoline direct injection engine can implement the compression ratio which is high enough to overcome the compression ratio of a conventional gasoline engine, thereby maximizing the fuel efficiency.

A fuel pressure is a very important factor in the gasoline direct injection engine, so a high pressure fuel pump having high performance is required for the fuel pressure.

The present applicant has filed many applications disclosing the high pressure fuel pump for the gasoline direct injection engine, such as the following patent document 1.

FIG. 1 is a perspective view of a high pressure fuel pump for a gasoline direct injection engine according to the related art, and FIG. 2 is a front sectional view of the high pressure fuel pump shown in FIG. 1.

The high pressure fuel pump for the gasoline direct injection engine according to the related art is mounted to an engine camshaft and a piston of the pump moves by a rotational force of a pump shaft as the pump shaft rotates by a rotational force of a cam, thereby generating a pressure and supplying gasoline fuel to the injector.

In detail, as show in FIGS. 1 and 2, the high pressure fuel pump for the gasoline direct injection engine according to the related art includes: a body (1) having a suction member (2) which includes a piston (2a) and a return spring (2b) for sucking fuel therein, having a side surface formed in both sides thereof with inlet-side and outlet-side openings (3 and 4), provided on an upper portion thereof with a coupling part (5) where a damper part (6) is mounted, and formed in outer side thereof with an introduction hole (la) and a discharge hole (1b) through which the fuel is introduced and discharged; the damper part (6) coupled to the coupling part (5) of the body (1) for reducing pulsation of the sucked fuel; a spill valve (7) coupled to the inlet-side opening (3) for controlling a supply flow rate and a discharge pressure; an inlet-side check valve (8) coupled to the inlet-side opening (3) and connected to the spill valve (7); and an outlet-side check valve (9) coupled to the outlet-side opening (4).

The spill valve (7) controls the inlet-side check valve (8) to be opened and closed by an operation of a solenoid so that the fuel introduced through the introduction hole (la) is transferred to the outlet-side check valve (9) via the inlet-side check valve (8), and controls an opening and closing degree of the inlet-side check valve (8) under the control of the solenoid so as to adjust a supply amount of the fuel.

Accordingly, the high pressure fuel pump for the gasoline direct injection engine according to the related art compresses the gasoline fuel introduced through the introduction hole (la) at a high pressure by supplying the gasoline fuel to a high pressure chamber (C) via the damper part (6) and the spill valve (7), and supplies the compressed gasoline fuel to the injector by discharging the compressed gasoline fuel through the discharge hole (1b) via the outlet-side check valve (9).

Meanwhile, a pressure relief valve (PRV) is provided on the outlet-side opening (3), in which the pressure relief valve relieves an abnormal high pressure generated in a fuel supply system by transferring a part of the gasoline fuel discharged through the discharge hole (1b) to the high pressure chamber (C) when the abnormal high pressure exceeding a preset pressure limit is generated in the fuel supply system for supplying the fuel discharged from the high pressure fuel pump to the injector.

Thus, the high pressure fuel pump for the gasoline direct injection engine according to the related art has a structure that the outlet-side check valve (9) and the pressure relief valve (PRV) are separately manufactured and inserted into the outlet-side opening (4) of the body (1).

### RELATED DOCUMENTS

### Patent Documents

(Patent document 1) Korean Patent Registration No. 10-1171995 (published on Aug. 8, 2012)

### SUMMARY OF THE INVENTION

FIG. 3 is a sectional plan view of a high pressure fuel pump modified from the high pressure fuel pump shown in FIG. 2.

As described above, the high pressure fuel pump for the gasoline direct injection engine according to the related art includes the outlet-side check valve (9) for forming a high pressure, and the pressure relief valve (PRV) for relieving the abnormal high pressure in the fuel supply system which supplies the gasoline fuel pressurized at the high pressure to the injector.

In the high pressure fuel pump for the gasoline direct injection engine according to the related art, the outlet-side check valve (9) and the pressure relief valve (PRV) are laid up and down in parallel with each other along the horizontal direction as shown in FIG. 2, or arranged on the same plane as shown in FIG. 3, and the pressure relief valve (PRV) has a structure for transferring the abnormal high pressure generated in the fuel supply system to the high pressure chamber (C).

Therefore, the high pressure fuel pump for the gasoline direct injection engine according to the related art has a problem that it is difficult to completely relieve the abnormal high pressure generated in the fuel supply system when a high pressure is formed inside the high pressure chamber.

In addition, in the high pressure fuel pump for the gasoline direct injection engine according to the related art, when the outlet-side check valve and the pressure relief valve are installed on the same plane as shown in FIG. 3, the outlet-side opening of a discharge passage where the outlet-side check valve is installed is biased to one side, thereby serving as the resistance which impedes the discharge of the fuel pressurized at the high pressure.

Accordingly, the high pressure fuel pump for the gasoline direct injection engine according to the related art has a problem that the pressure loss occurs due to the resistance generated in the discharge process of the gasoline fuel pressurized at the high pressure.

In addition, the high pressure fuel pump for the gasoline direct injection engine according to the related art has a problem that the assembly work is difficult and the workability is lowered because the outlet-side check valve and the pressure relief valve are assembled through the outlet-side opening in a manufacturing process.

To solve the problems described above, an object of the present invention is to provide a high pressure fuel pump capable of rapidly relieving the abnormal high pressure generated in the fuel supply system.

Another object of the present invention is to provide a high pressure fuel pump capable of improving the operation performance of a relieving operation for the abnormal high pressure generated in the fuel supply system, and improving the assembly capability of the high pressure fuel pump.

Still another object of the present invention is to provide a high pressure fuel pump capable of preventing the pressure loss by removing the resistance impeding the flow of the fuel pressurized at the high pressure in the discharge process.

To achieve the objects described above, according to the present invention, there is provided a high pressure fuel pump including: a body formed in a side surface thereof with a discharge hole; a pressurizing device for generating a suction force for sucking fuel supplied from a fuel tank and a pressurizing force for pressurizing the fuel at a high pressure; a seal carrier coupled to a lower portion of the body and coupled with the pressurizing device; a flow control valve coupled to one side of the body, for controlling a supply flow rate and a discharge pressure of the fuel; and a pressure relief valve for relieving an abnormal high pressure by transferring a part of discharged fuel to a low pressure space formed in the lower portion of the body when the abnormal high pressure exceeding a preset pressure limit is generated in a fuel supply system for supplying the fuel discharged through the discharge hole to an injector, wherein the pressure relief valve is disposed in parallel with a piston provided in the pressurizing device inside the body.

As described above, according to the high pressure fuel pump of the present invention, the pressure relief valve is installed in a transfer passage formed in parallel with the piston inside the body, and relieves the abnormal high pressure by transferring a part of fuel discharged through the discharge hole to the low pressure space through the transfer passage by opening the pressure relief valve when the abnormal high pressure is generated in the fuel supply system.

Thus, according to the present invention, since the fuel is transferred to the low pressure space upon the relief of the abnormal high pressure, the abnormal high pressure can be rapidly relieved compared to the related art where the fuel is transferred to the high pressure chamber to relieve the abnormal high pressure.

In addition, according to the present invention, the shape of the transfer passage is changed to dispose an inlet-side check valve and an outlet-side check valve in the same line, so that the resistance that impedes the flow of fuel in a process of pressurizing the fuel at the high pressure and discharging the pressurized fuel can be minimized, thereby preventing the pressure loss of the high pressure fuel pump.

In addition, according to the present invention, the pressure relief valve is assembled through the transfer passage formed in the body along the vertical direction, and the outlet-side check valve is assembled through the discharge hole, so that the difficulty level of assembling the pressure relief valve and the outlet-side check valve can be lowered, thereby improving workability upon the assembly work of the high pressure fuel pump.

### BRIEF DESCRIPTION OF THE DRAWINGS

FIG. 1 is a perspective view of a high pressure fuel pump for a gasoline direct injection engine according to the related art.

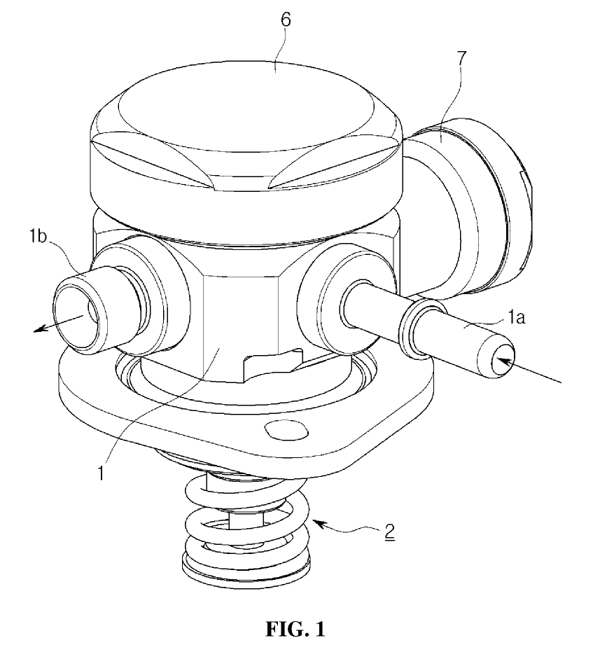

FIG. 2 is a front sectional view of the high pressure fuel pump shown in FIG. 1.

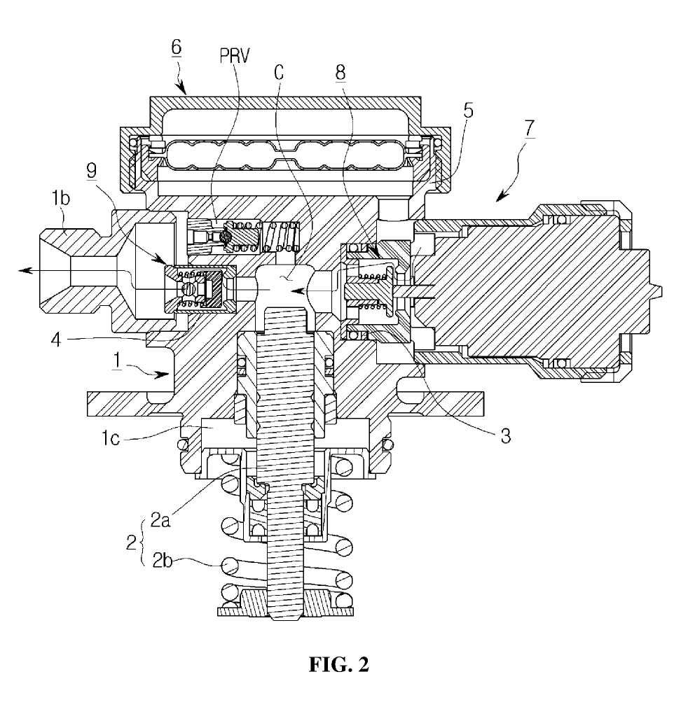

FIG. 3 is a sectional plan view of a high pressure fuel pump modified from the high pressure fuel pump shown in FIG. 2.

FIG. 4 is a perspective view of a high pressure fuel pump for a gasoline direct injection engine according to a preferred embodiment of the present invention.

FIG. 5 is a front sectional view of the high pressure fuel pump shown in FIG. 4.

FIG. 6 is an exploded perspective view of a pressure relief valve.

FIG. 7 is a view showing an operational state of the high pressure fuel pump sucking, pressurizing and discharging gasoline fuel.

FIG. 8 is a view showing an operational state of relieving an abnormal high pressure when the abnormal high pressure is generated in a fuel supply system.

### DETAILED DESCRIPTION OF THE INVENTION

Hereinafter, a high pressure fuel pump according to a preferred embodiment of the present invention will be described in detail with reference to the accompanying drawings.

For convenience of explanation, a flow control valve provided in the high pressure fuel pump for the gasoline direct injection engine is used for explanation as follows.

However, the present invention is not necessarily limited thereto, but can be applied to various types of internal combustion engines other than the gasoline direct injection engine, in which the internal combustion engines such as a direct injection LPG engine pressurize various fuels at a high pressure and directly inject the various fuels into a combustion chamber.

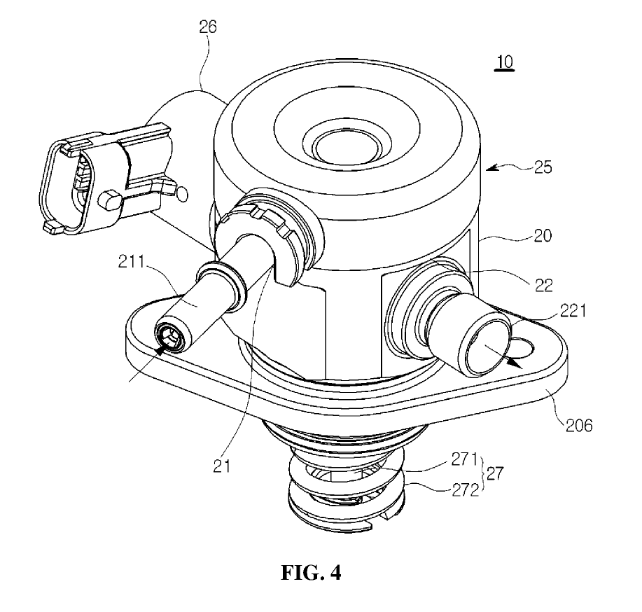

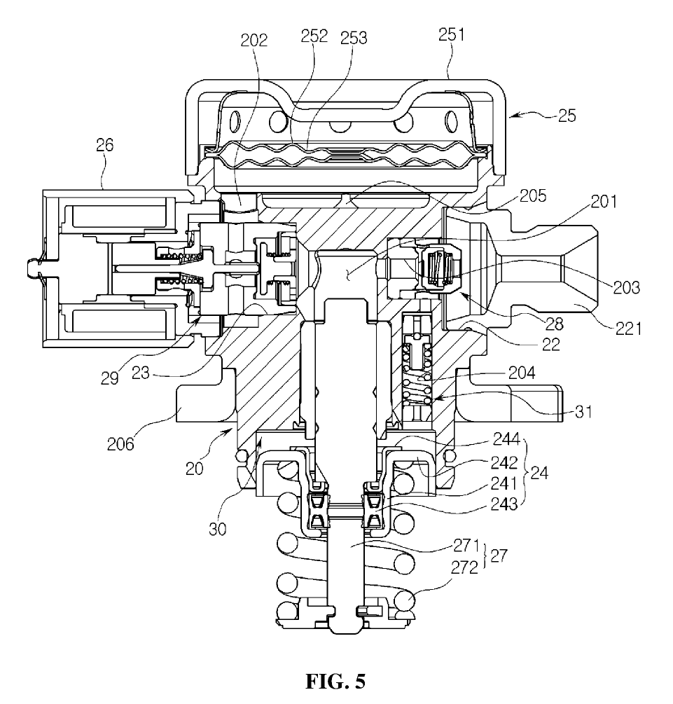

FIG. 4 is a perspective view of the high pressure fuel pump for the gasoline direct injection engine according to the preferred embodiment of the present invention, and FIG. 5 is a front sectional view of the high pressure fuel pump shown in FIG. 4.

Hereinafter, the term indicating a direction such as “left”, “right”, “front”, “rear”, “upper” and “lower” is defined to indicate each direction, respectively, on the basis of the state shown in the drawings.

As shown in FIGS. 4 and 5, the high pressure fuel pump 10 for the gasoline direct injection engine according to the preferred embodiment of the present invention includes: a body 20 formed in a side surface thereof with a discharge hole 22; a pressurizing device 27 for generating a suction force for sucking fuel supplied from a fuel tank (not shown in the drawings) and a pressurizing force for pressurizing the fuel at a high pressure; a seal carrier 24 coupled to a lower portion of the body 20 and coupled with the pressurizing device 27; and a spill valve 26 coupled to one side of the body 20, for controlling a supply flow rate and a discharge pressure of the fuel.

In addition, the high pressure fuel pump 10 may further include: a roller tappet unit (not shown in the drawings) provided between the body 20 and a cam provided on an engine camshaft (not shown in the drawings), for converting a rotary motion of the cam into a linear reciprocating motion to transfer the linear reciprocating motion to the pressurizing device 27; and a damper part 25 coupled to an upper portion of the body 20 and having a suction port 21 through which the fuel is sucked, for reducing pulsation of the sucked fuel.

In addition, the high pressure fuel pump 10 may further include a pressure relief valve 31 installed in parallel with a piston 271 of the pressurizing device 27 inside the body 20 along a vertical direction, for relieving an abnormal high pressure by transferring a part of discharged gasoline fuel to a low pressure space 30 formed in a lower portion of the piston 271 when the abnormal high pressure exceeding a preset pressure limit is generated in a fuel supply system (not shown in the drawings) for supplying gasoline fuel discharged from the high pressure fuel pump 10 to an injector.

The pressurizing device 27 functions to generate the suction force and the pressurizing force into the body 20 for the fuel.

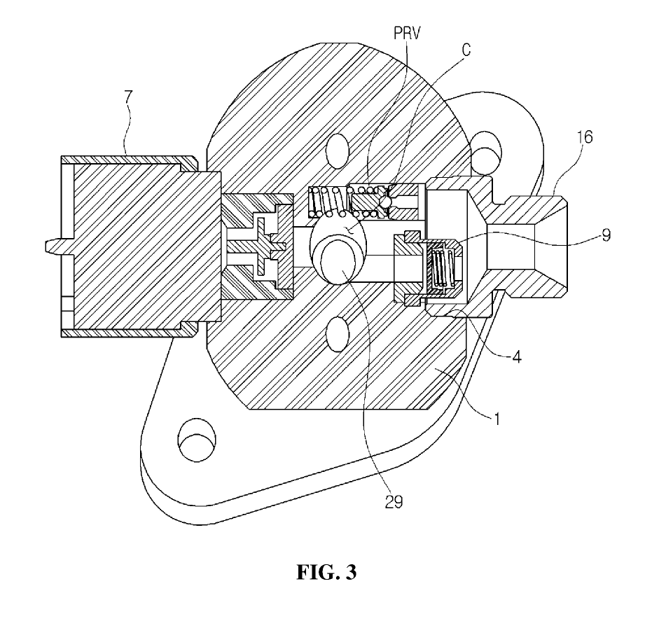

To this end, as shown in FIG. 3, the pressurizing device 27 may include the piston 271 connected to the camshaft of an engine via the roller tappet unit to move up and down, and a return spring 272 coupled to the piston 271 to provide a restoring force.

The body 20 may be formed in a substantially cylindrical shape, the discharge hole 22 may be formed at one side of the body 20, and a coupling hole 23 coupled to the spill valve 26 may be formed at a position symmetrical to the discharge hole 22.

The body 20 may be formed at a central portion thereof with a high pressure chamber 201 for pressurizing the gasoline fuel sucked by the up-down movement of the piston 271 to a preset high pressure state.

In addition, the body 20 may be formed therein with a supply passage 202 for supplying the fuel sucked through the suction hole 21 formed in the damper part 25 to the high pressure chamber 201, and a discharge passage 203 for discharging the fuel pressurized at the high pressure by the high pressure chamber 201 to the discharge hole 22.

In addition, the low pressure space 30 may be formed between the lower portion of the body 20 and the seal carrier 24 to store the fuel in a low pressure state.

To this end, the body 20 may be formed therein with a transfer passage 204 for transferring a part of the fuel discharged through the discharge hole 22 to the low pressure space 30 to relieve the abnormal high pressure when the abnormal high pressure is generated in the fuel supply system, and a communication passage 205 for allowing the low pressure space 30 to communicate with the damper part 25.

The pressure relief valve 31 may be installed in the transfer passage 204.

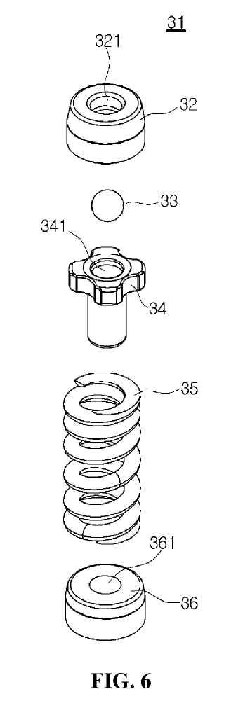

FIG. 6 is an exploded perspective view of a pressure relief valve.

As shown in FIG. 6, the pressure relief valve (31) may include a seat 32 mounted in an upper portion of the transfer passage 204 and having a transfer hole 321 for transferring a part of the fuel discharged through the discharge hole 22 to the low pressure space 30; a ball 33 for selectively opening and closing the transfer hole 321; a ball guide 34 having a guide surface 341 with a shape corresponding to the ball 33; an elastic body 35 for providing a restoring force to the ball guide 34; and a stopper 36 mounted in a lower portion of the transfer passage 204, for fixing a lower end of the elastic body 35.

The stopper 36 is formed at a central portion thereof with a flow hole 361 for moving the fuel transferred through the transfer hole 204 to the low pressure space 30 when the pressure relief valve (31) is opened.

Referring again to FIG. 5, the damper part 25 may include a damper cover 251 formed in a cylindrical shape having an open bottom such that the damper cover 251 is coupled to the upper portion of the body 20, and a damper 252 installed in an inner space of the damper cover 251 to reduce pulsation of the fuel.

A suction hole 21 through which the gasoline fuel is supplied may be formed at one side of the damper cover 251, for example, one side surface or an upper surface of the damper cover 251.

A plurality of furrows 253 may be formed on an outer surface of the damper 252, that is, an upper surface and a lower surface of the damper 252.

The damper part 25 reduces the fuel pulsation generated when the fuel is sucked only during the suction operation of the piston 271 provided in the pressurizing device 27, so that the fuel is stably transferred.

The damper part 25 may be removed when the fuel pulsation has an insignificant influence on the performance of the high pressure fuel pump 10, because the magnitude the fuel pulsation generated in the pumping operation differs according to the specifications of the high pressure fuel pump 10.

When the damper part 25 is removed, the present invention can be modified so that the suction hole 21 is formed on one side surface of the body 20.

Meanwhile, the lower portion of the body 20 may be formed in a cylindrical shape having an open bottom, and the seal carrier 24 having the low pressure space 30 may be coupled to an inner circumferential surface of a lower end portion of the body 20.

The pressurizing device 27 for generating the suction force and the pressurizing force for the fuel may be coupled to a lower portion of the seal carrier 24.

The seal carrier 24 may include a cylinder part 241 having a central portion coupled to the piston 271, and a ring part 242 formed in a ring shape and coupled to an upper end of the cylinder part 241.

A lower end of the cylinder part 241 may be bent toward the piston 271 coupled to the central portion of the cylinder part 241, and an outer end of the ring part 242 may be bent downwards to seal the lower portion of the body 20.

A piston seal 243 and a seal stopper 244 may be provided between the cylinder part 241 and the piston 271 to prevent the fuel filled in the low pressure space 30 from being leaked to the outside.

Meanwhile, a bracket 206 functioning as a flange for fixing the high pressure fuel pump 10 to a vehicle body may be coupled to a lower outer circumferential surface of the body 20.

In addition, the body 20 is provided therein with an outlet-side check valve 28 coupled to the discharge hole 22, and an inlet-side check valve 29 for opening and closing the coupling hole 23 by the spill valve 26, and supplying the fuel sucked into the body 20 to the outlet-side check valve 28 while preventing the backflow of the fuel.

The suction hole 21 and the discharge hole 22 may be provided with a suction port 211 and a discharge port 221, respectively.

In addition, the inlet-side check valve 29 and the outlet-side check valve 28 may be arranged in the same line so as to minimize the resistance impeding the flow of the fuel in the process of pressurizing the fuel at the high pressure and discharging the pressurized fuel.

Accordingly, the present invention may minimize the resistance generated during the process of pressurizing and discharging the gasoline fuel, thereby preventing the pressure loss of the high pressure fuel pump.

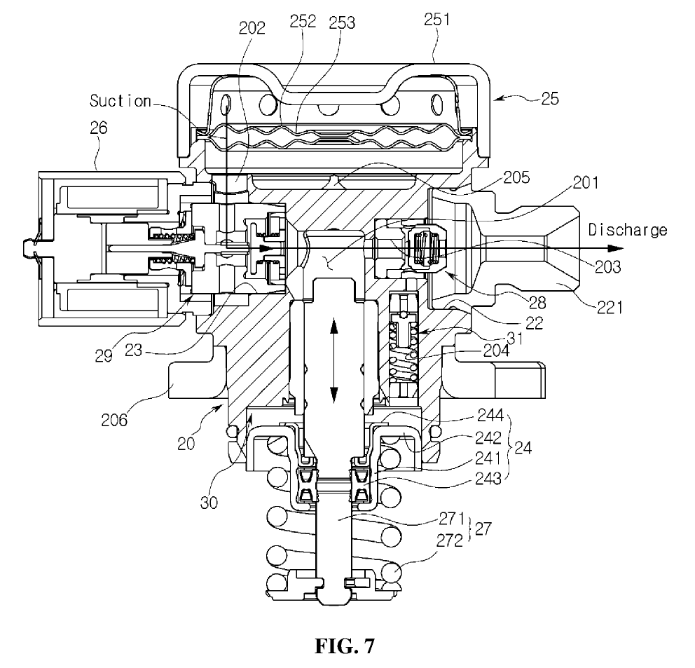

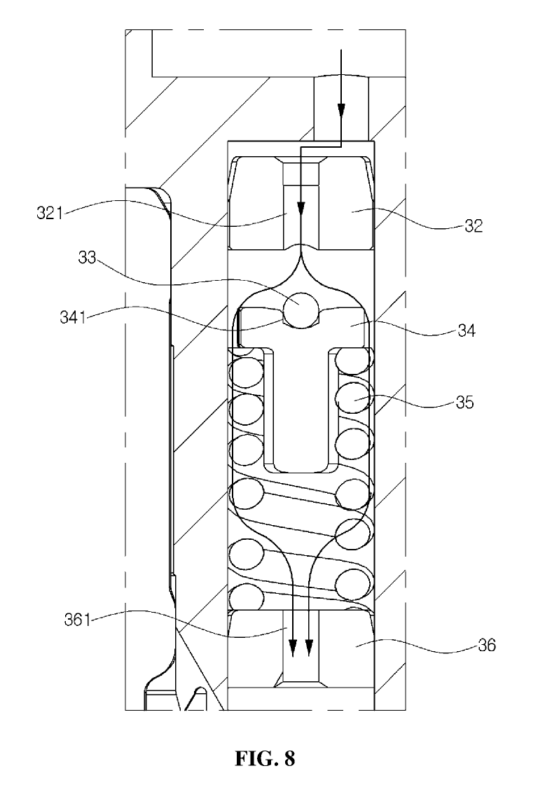

Next, a coupling structure and an operation method of the high pressure fuel pump for the gasoline direct injection engine according to the preferred embodiment of the present invention will be described in detail with reference to FIGS. 7 and 8.

FIG. 7 is a view showing an operational state of the high pressure fuel pump sucking, pressurizing and discharging gasoline fuel, and FIG. 8 is a view showing an operational state of relieving an abnormal high pressure when the abnormal high pressure is generated in a fuel supply system.

First, a worker couples the piston 271 and the return spring 272, and installs the piston 271 inside the body 20.

Then, the worker assembles the pressure relief valve 31 to the transfer passage 204 formed inside the body 20 along the vertical direction such that the pressure relief valve 31 is disposed in parallel with the piston 271.

At this time, the worker sequentially couples the seat 32, the ball 33, the ball guide 34, and the elastic body 35 of the pressure relief valve 31 upwards from a lower end of the transfer passage 204, and finishes the assembly of the pressure relief valve 31 by mounting the stopper 36 at a lower end of the transfer passage 204.

Then, the worker installs the outlet-side check valve 28 through the discharge hole 22 formed in one side of the body 20, and couples the discharge port 221 to the discharge hole 22.

As described above, according to the present invention, the pressure relief valve is assembled through the transfer passage formed in the body along the vertical direction, and the outlet-side check valve is assembled through the discharge hole, so that the assembling work of the pressure relief valve and the outlet-side check valve may be performed smoothly.

Accordingly, the present invention may improve the workability during the assembly work of the high pressure fuel pump.

Similarly, the inlet-side check valve 29 is installed through the coupling hole formed in one side of the body 20, and the spill valve 26 is coupled thereto.

The damper part 25 is coupled to the upper portion of the body 20, the suction port 211 is coupled to the suction hole 21 formed in one side surface or an upper surface of the damper part 25, and a fuel supply line (not shown in the drawings) is connected to the suction port 211.

The high pressure fuel pump 10 assembled through the above process performs suction, pressurization, and discharge operations of the fuel as the piston 271 moves up and down in conjunction with the camshaft when the engine is driven.

In other words, the suction force is generated in an inner space of the body 20 when the piston 271 moves downward, so that the fuel is sucked into the inner space of the body 20 through the suction hole 21 and the supply passage 202 formed in the damper part 25, and the sucked fuel is transferred to the high pressure chamber 201.

At this time, the spill valve 26 opens and closes the inlet-side check valve 29 provided between the damper part 25 and the pressurizing device 27 to control the supply flow rate and the discharge pressure of the fuel.

As shown in FIG. 7, the fuel transferred to the high pressure chamber 201 is pressurized by the up-down movement of the piston 271, and when the fuel is pressurized to a preset pressure, the pressurized fuel is discharged to the fuel supply system through the discharge passage 203 and the discharge hole 22 as the outlet-side check valve 28 is opened.

Meanwhile, when the abnormal high pressure is generated in the fuel supply system, the abnormal high pressure is formed in the fuel supply line, so that the ball 33 and the ball guide 34 of the pressure relief valve 31 are moved downwards while elastically deforming the elastic body 35 such that a length of the elastic body 35 is reduced as shown in FIG. 8.

Accordingly, a part of the gasoline fuel discharged through the discharge hole 22 passes through the transfer hole 321 of the seat 32 and the flow hole 361 of the stopper 36, and flows into the low pressure space 30 via the transfer passage 204.

As described above, according to the present invention, when the abnormal high pressure is generated in the fuel supply system, the pressure relief valve is opened to move a part of the fuel discharged to the low pressure space formed in the lower portion of the body, thereby relieving the abnormal high pressure.

Particularly, according to the present invention, since the fuel is transferred to the low pressure space upon the relief of the abnormal high pressure, the abnormal high pressure can be rapidly relieved compared to the related art where the fuel is transferred to the high pressure chamber to relieve the abnormal high pressure.

At this time, the fuel that has been transferred to the low pressure space 30 to relieve the abnormal high pressure in the fuel supply system may be supplied to the damper part 25 through the communication passage 205 formed inside the body 20, and the fuel may be supplied again to the high pressure chamber 201 through the supply passage 202 when the high pressure fuel pump 10 operates normally.

Through the above process, the present invention may relieve the abnormal high pressure by installing the pressure relief valve in the transfer passage formed in parallel with the piston inside a body, and transferring a part of the fuel discharged through the discharge hole to the low pressure space via the transfer passage by opening the pressure relief valve when the abnormal high pressure is generated in the fuel supply system.

Although the present invention implemented by the inventor is described in detail according to the embodiments, the present invention is not limited to the embodiments and may be variously modified within a range not departing from the scope of the present invention.

In other words, the flow control valve provided in the high pressure fuel pump for the gasoline direct injection engine is used for explanation in the above embodiments. However, the present invention is not necessarily limited thereto, but can be employed in various types of engines other than the gasoline direct injection engine.

For example, the present invention may be applied to the gasoline direct injection engine, and may also be modified to be applied to various internal combustion engines, in which various fuels, for example, a liquefied petroleum gas (LPG) or compressed natural gas (CNG) fuel, are pressurized at the high pressure and directly injected into a combustion chamber, such as the direct injection LPG engine.

The present invention can be applied to a technology of the high pressure fuel pump for the gasoline direct injection engine, in which the high pressure fuel pump pressurizes the gasoline fuel at a preset high pressure and supplies the pressurized fuel, and relieves the abnormal high pressure by transferring a part of the discharged fuel to the low pressure space inside the body when the abnormal high pressure is generated in the fuel supply system.

What is claimed is:

1. A high pressure fuel pump comprising:
a body formed in a side surface thereof with a discharge hole;
a pressurizing device for generating a suction force for sucking fuel supplied from a fuel tank and a pressurizing force for pressurizing the fuel at a high pressure;
a seal carrier coupled to a lower portion of the body and coupled with the pressurizing device;
a flow control valve coupled to one side of the body, for controlling a supply flow rate and a discharge pressure of the fuel; and
a pressure relief valve for relieving an abnormal high pressure by transferring a part of discharged fuel to a low pressure space formed in the lower portion of the body when the abnormal high pressure exceeding a preset pressure limit is generated in a fuel supply system for supplying the fuel discharged through the discharge hole to an injector,
wherein the pressure relief valve is disposed in parallel with a piston provided in the pressurizing device inside the body.

2. The high pressure fuel pump of claim 1, wherein the body is formed at one side thereof with the discharge hole and a coupling hole coupled to the flow control valve is formed at a position symmetrical to the discharge hole,
the body is formed at a central portion thereof with a high pressure chamber for pressurizing the fuel sucked by up-down movement of the piston to a preset high pressure state,
the body is formed in the lower portion thereof with the low pressure space for storing the fuel in a low pressure state before the fuel is pressurized to the high pressure state, and
the body is formed therein with a supply passage for sucking the fuel and supplying the fuel to the high pressure chamber, a discharge passage for discharging the fuel pressurized to the high pressure state by the high pressure chamber to the discharge hole, and a transfer passage provided with the pressure relief valve, for transferring a part of the fuel discharged through the discharge hole to the low pressure space by opening the pressure relief valve so as to relieve the abnormal high pressure when the abnormal high pressure is generated in the fuel supply system.

3. The high pressure fuel pump of claim 2, wherein the body is formed therein with a communication passage for allowing the low pressure space to communicate with a damper part,
the coupling hole is provided with an inlet-side check valve for opening and closing the supply passage according to an operation of the flow control valve,
the discharge hole is provided with an outlet-side check valve opened and closed to discharge the fuel sucked in the high pressure chamber to the discharge hole when the fuel is pressurized to the preset high pressure state, and
the inlet-side check valve and the outlet-side check valve are installed in a same line to minimize resistance occurring during suction, pressurization, and discharge processes of the fuel.

4. The high pressure fuel pump of claim 2, further comprising:
a roller tappet unit provided between the body and a cam provided on an engine camshaft, for converting a rotary motion of the cam into a linear reciprocating motion to transfer the linear reciprocating motion to the pressurizing device; and
a damper part coupled to an upper portion of the body and having a suction port through which the fuel is sucked, for reducing pulsation of the sucked fuel,
wherein the body is provided with a communication passage for allowing the low pressure space to communicate with the damper part, and
the fuel transferred to the low pressure space when the abnormal high pressure is generated in the fuel supply system is supplied to the high pressure chamber through the communication passage via the damper part and the supply passage when the abnormal high pressure is relieved.

5. The high pressure fuel pump of claim 2, wherein the pressure relief valve comprises:
a seat mounted in an upper portion of the transfer passage and having a transfer hole for transferring a part of the fuel discharged through the discharge hole to the low pressure space;
a ball for selectively opening and closing the transfer hole;
a ball guide having a guide surface with a shape corresponding to the ball;
an elastic body for providing a restoring force to the ball guide; and
a stopper mounted in a lower portion of the transfer passage, for fixing a lower end of the elastic body,
wherein the stopper is formed therein with a flow hole for moving the fuel transferred through the transfer hole to the low pressure space.
